(19) United States
(12) Patent Application Publication
(10) Pub. No.: US 2004/0192368 A1
(43) Pub. Date: Sep. 30, 2004

(54) Method and mobile communication device for receiving a dispatch call

(76) Inventors: David W. Edwards, Scottsdale, AZ (US); Deepak Ahya, Plantation, FL (US)

Correspondence Address: Scott M. Garrett, Motorola, Inc., Law Department, 8000 West Sunrise Boulevard, Fort Lauderdale, FL, 33322, US

(21) Appl. No.: 10/403,610

(22) Filed: Mar. 31, 2003

(51) Int. Cl. H04B 7/00; H04Q 7/20

(52) U.S. Cl. 455/521

(57) ABSTRACT

A mobile communication device capable of engaging in dispatch calling receives an initial dispatch call burst (404). The initial dispatch call burst is buffered (410) in a buffer memory (208) of the mobile communication device, and an alert (410) is given to the user of the mobile communication device. When the user accepts the dispatch call (412), the mobile communication device plays (414) the buffered initial dispatch call burst over an earpiece (214) or speaker of the mobile communication device. The mobile communication device therefore permits dispatch cal operation in mobile communication devices without a loudspeaker, as well as with those that are equipped with a loudspeaker, but operated in a quiet mode.

### TECHNICAL FIELD

This invention relates in general to wireless communication technology, and in particular to mobile communication devices capable of engaging in dispatch communication.

### BACKGROUND OF THE INVENTION

Mobile communication devices are used for a wide variety of communication services, and by a rapidly growing number of users. In metropolitan regions mobile communication devices are widely used for personal and business communications, to an extent such that they are one of the most commonly owned electronic devices in these areas. Most mobile communication devices are used for mobile telephony service, but some support a so called “dispatch” mode of communication. Traditionally dispatch communication referred to two way radio use in fleet systems which had a dispatcher at a central location. In recent years dispatch communication has expanded in the private market, and people use it as an alternative to mobile telephony for short calls to other people a user may speak with several times a day, as in businesses. Private dispatch communication service is typically facilitated by a fixed equipment network much like a cellular telephone network. Whereas telephony is full duplex communication where both parties can speak at the same time, dispatch communication is half duplex voice communication, and typically the received signal is played over a loudspeaker instead of a low volume earpiece. Furthermore, dispatch call set-up is desired to be a quick as possible so as to simulate a two-way radio call. The rapid call set-up compared to mobile telephony, and the lower fees charged by communication service providers have made private dispatch calling very popular in many markets. Presently, dispatch calling is provided by mobile communication devices that are capable of both mobile telephony calling, as well as both group and private dispatch calling. Mobile communication devices manufactured by Motorola, Inc., and sold under the trade name iDEN are examples of such mobile communication devices.

When receiving a dispatch call, the user is not required to “answer” the call by, for example, pressing an off-hook button, as in answering a telephone call. Instead, the mobile communication device automatically receives the incoming voice information, and plays it over a loudspeaker of the mobile communication device as it is received. While this has the benefit of getting the voice information to the party being called as rapidly as possible, it has a disadvantage in some situations. For example, if the person receiving the call is in a meeting or similar activity, receiving a dispatch call can be disruptive and therefore undesired. One solution to this is to allow the user to switch the audio from the loudspeaker to the earpiece. In that way when a call comes in for the mobile communication device, the audio is played over the quieter earpiece and an alert is given to the user in the form of an audible beep, chirp, or similar sound, or a tactile alert as is produced by a vibrating motor, or both. However, that presents a problem because, unless the user has an earphone on, the initial voice burst will not be heard by the user, which necessitates the user asking the caller to repeat what the caller said. This problem is also present when contemplating a lower cost, smaller dispatch call capable mobile communication device that has no loudspeaker. Therefore there is a need for a means by which a dispatch call can be received at a mobile communication device using a low audio speaker, such as an earpiece, without the user of the mobile communication device missing the initial voice burst of the call.

### BRIEF DESCRIPTION OF THE DRAWINGS

FIG. 1 shows a system schematic diagram of a dispatch calling system in which the invention is practiced;

FIG. 2 shows a block schematic diagram of a mobile communication device for use with the invention;

FIG. 3 shows a block schematic diagram of an alternative mobile communication device for use with the invention; and

FIG. 4 shows a flow chart diagram of a method of receiving a dispatch call, in accordance with the invention.

### DETAILED DESCRIPTION OF A PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

The invention solves the problem of forcing a user to either receive a dispatch call normally, and possibly disrupt activities the user is presently engaged in, or to miss the initial voice burst from the calling party, by buffering the initial voice burst in a buffer memory of the mobile communication device. The mobile communication device then alerts the user of the incoming call, and upon receiving an indication of acceptance from the user, the mobile communication device then plays the buffered voice data over the earpiece of the mobile communication device. Furthermore, in a software implementation of the invention, the software determines whether or not a loudspeaker is present in the mobile communication device before checking to see if the user has set the device in a quiet mode. So designed, the software can be loaded into a variety of mobile communication devices, including those that are built without a loudspeaker. In this way the same software can be used on cost/size reduced dispatch-capable mobile communication devices as well as on the full featured dispatch-capable mobile communication devices.

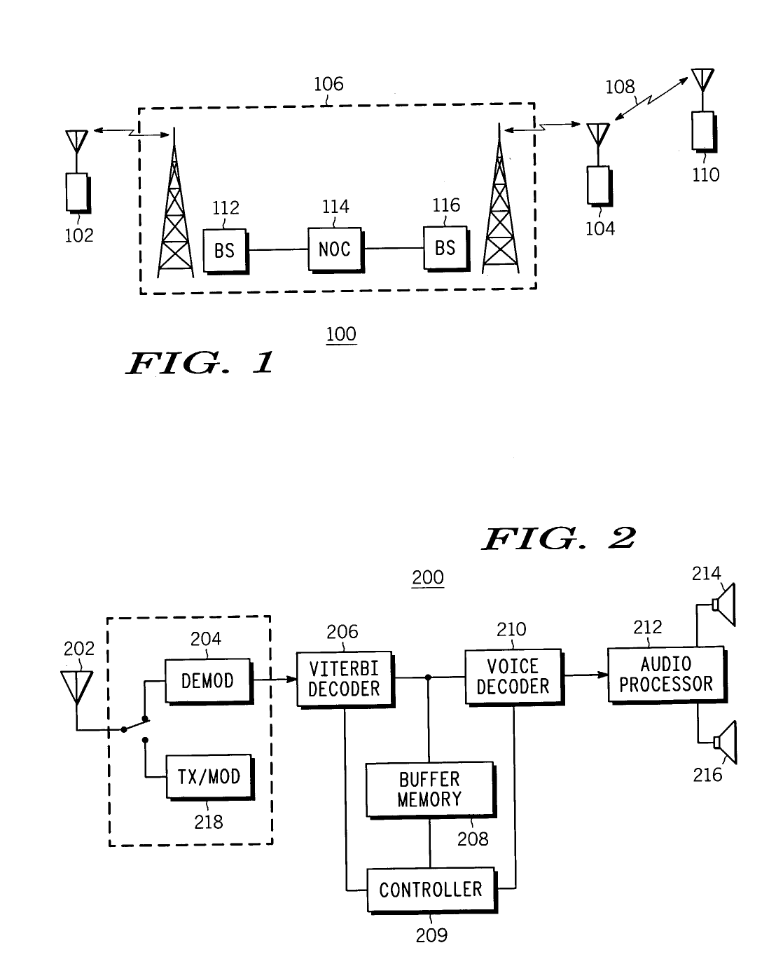

Referring now to FIG. 1, there is a shown a system schematic diagram 100 of a dispatch calling system in which the invention is practiced. There are two principle ways by which dispatch calling can be engaged; network assisted and direct. Network assisted refers to the scheme where a fixed equipment network is used to process calls and transport voice information from one serving cell to another. Direct dispatch calling refers to the mobile communication devices transmitting signals to, and receiving signals from other mobile communication devices directly, without the aid of a fixed equipment network. In each case the dispatch call begins at an initiating mobile communication device 102, 110 when the user of the initiating device attempts to call the user of a target device 104 using a dispatch mode of communication. Mobile communication device 102 is shown using a network assisted mode, while mobile communication device 110 is shown using a direct mode, and communicates directly with the target mobile communication device. In the network assisted scheme, the initiating device transmits to a fixed equipment network 106. The fixed equipment network may be as simple as a repeater or repeater network to a state or nationwide wide area mobile communications network. In the preferred embodiment, the network 106 is designed in accordance with the teachings of U.S. Pat. No. 5,548,631 to Krebs et al, titled “Method and apparatus for supporting at least two communication services in a communication system,” and assigned to the assignee of the present patent application, the disclosure of which is hereby incorporated by reference. Typically the network includes a number of base stations 112, 114 set up in a geographic coverage pattern to establish serving cells in the vicinities of the base stations, as is well known in the art. The base stations contain transceiver equipment to provide an air interface in the serving cell so that mobile communication devices in the serving cell can use communication resources, as is well known. The base stations communicate with a network operations center 114, which controls calling resources, switching, and administration, as is well known in the art. When the initiating mobile communication device 102 calls the target mobile communication device 104, the network locates the target mobile communication device, and sets up a dispatch call circuit, and begins forwarding voice data from the initiating mobile communication device to the target mobile communication device without any action on the part of the user of the target mobile communication device. Alternatively, the mobile communication devices may communicate directly 108, without the use of a network, as is indicated by mobile communication device 110.

Referring now to FIG. 2, there is shown a block schematic diagram 200 of a mobile communication device for use with the invention. In particular, the receive path of the mobile communication device is shown here. The mobile communication device has an antenna 202 for receiving and transmitting radio frequency signals. The antenna is coupled to a receiver front end which includes a demodulator 204. The demodulator removes the transmitted signal from the carrier wave used to transmit the signal. In the preferred embodiment the output of the demodulator is a digital signal, which is fed to a viterbi decoder 206. The vertbi decoder removes the error correction applied by the transmitter to make the signal robust for transmission over the air. After the viterbi decoder, what remains is a voice signal in voice encoded digital form.

When the initiating user first calls the target user, the initiating user typically presses, for example, a push to talk button, which causes the initiating mobile communication device to transmit dispatch call set up signaling to the network. Shortly thereafter, the initiating user begins speaking, and this initial voice burst is sent to the target user's mobile communication device. By voice burst or dispatch call burst, it is meant the voice signal created by the user of the calling mobile communication device in a dispatch call. Since dispatch communication is half duplex, a first party speaks while a second party listens. Then the second party speaks while the first party listens. These exchanges are referred to as bursts. Typically the initial voice or dispatch call burst is short, on the order of 30 seconds or less. The voice data is received at the target mobile communication device, and buffered in a buffer memory 208. The buffer memory may be a dedicated semiconductor memory, or it may be set up as a dynamically variable memory in a random access memory (RAM) used by the mobile communication device. If the voice encoding used is, for example, vector sum excited linear predictive (VSELP) coding at 4200 bits per second (bps), then 30 seconds of voice information will require about 16 kilobytes of buffet memory. A proposed 2200 bps AMBE++ encoded signal would use about 8.25 kilobytes per 30 seconds of voice data. After the voice signal is buffered, the target mobile communication device alerts the user by audible or tactile means. The user then indicates acceptance of the call by, for example, pressing a push to talk button. When the user has indicated acceptance of the call, the buffered voice signal is then sent from the buffer 208 to a voice decoder 210 which decodes the voice signal from, for example, VSELP form. The output of the decoder is fed to an audio processor 212 which generates an analog audio signal that is fed to a earpiece speaker 214. The mobile communication device also may include a loudspeaker 216 for playing the voice signal at a higher volume, at the user's option, such that the signal can be heard when the mobile communication device is held away from the user's ear. The mobile communication device also typically comprises a controller 209, for controlling functions of the other block present, and a transmitter 218 for transmitting signals. The transmitter and receiver, together, constitute a transceiver. The controller controls switching of data from the viterbi decoder 206 to either the voice decoder 210 of the buffer memory 208. The switching can be performed in any conventional manner, either logically or otherwise, as dictated by the particular application.

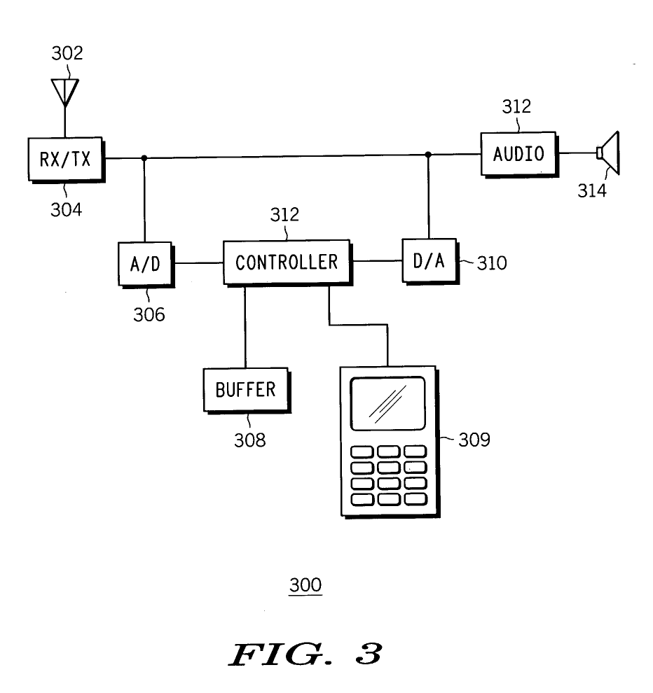

Referring now to FIG. 3, there is shown a block schematic diagram 300 of an alternative mobile communication device for use with the invention. This alternative mobile communication device is designed to receive analog signals. The mobile communication device receives and transmits signals via an antenna 302, which is coupled to a receiver and demodulator 304, which is part of the transceiver. The antenna will typically also be coupled to a transmitter (not shown) as well. The receiver receives the analog signal and extracts the analog voice signal, which would normally be fed to an audio processor 312 and played over a speaker 314. However, when the first voice burst is received, it must be stored. To facilitate storage of the analog voice signal, the mobile communication device of this alternative embodiment is provided with an analog to digital (A/D) converter 306. The A/D converts the analog voice signal into digital samples and passes them to a controller 307 which stores the samples in a buffer memory 308 until the user of the mobile communication device indicates acceptance of the call via user interface 309. Once the user indicates acceptance of the call, the controller retrieves the samples, and passes them to a digital to analog converter 310 which converts the digital samples to an analog signal or an analog approximation of the received signal which is passed to the audio processor 312 to be played over the earpiece speaker 314. As in FIG. 2, the controller 312 controls switching of the signal from the transceiver 304 to either the digital path of 306, 308, 310, and the audio processor 312 or further post processing. Switching is accomplished in a conventional manner and is left as a matter of engineering preference.

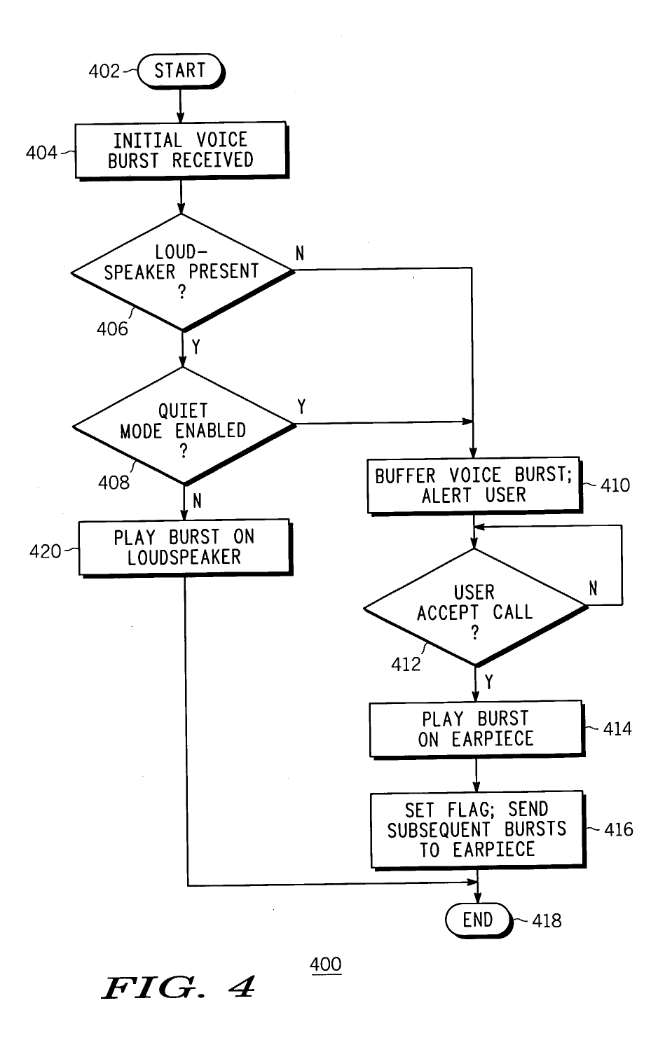

Referring now to FIG. 4, there is shown a flow chart diagram 400 diagramming a method of receiving a dispatch call, in accordance with the invention. The method shown and described here may be carried out by instructions stored in machine readable format in a memory of the mobile communication device. At the start 402 of the process, the mobile communication device is powered up and registered for service. The mobile communication device is of the type that has no loudspeaker, or the user has elected to have the loudspeaker turned off. Accordingly, when a dispatch call is received, the received initial audio or voice burst will not be played over a loudspeaker, as is conventional. The invention comes into use when the mobile communication device receives an initial audio or voice burst of a dispatch call (404), also referred to as an initial dispatch call burst. In the preferred embodiment, the software responsible for implementing the invention makes a determination as to whether a loudspeaker is present or not (406). This determination is important when, for example, common software is used in manufacturing both mobile communication devices with and without loudspeakers. If, for example, the software determines a loudspeaker is present, the user may have enabled a quiet mode of operation. Therefore, in such a case, the invention provides for determining if the mobile communication device is set to a quiet operating mode (408). If the mobile communication device is set to a quiet operating mode, or if the mobile communication device does not have a loudspeaker, the initial audio or voice burst is buffered and an alert is provided to the user of the mobile communication device (410). By alert, it is meant the mobile communication device takes an action to inform the user that a dispatch call has been received; this can be performed by, for example, a short audible alert, or a tactile or vibratory alert. The mobile communication device then waits for an input from the user of the mobile communication device (412) indicating the user is accepting the dispatch call. Once the user accepts the call, by, for example, pressing a button on the user interface of the mobile communication device, the mobile communication device plays the buffered audio or voice signal (414). The mobile communication device also takes action so that audio or voice bursts received from the calling party subsequently are routed directly to the mobile communication device's earpiece (416). That is, when the user indicates acceptance of the dispatch call, it is assume the user has placed the earpiece of the mobile communication device to the user's ear, and therefore there is no need to buffer subsequent voice bursts received during the call. This can easily be done by, for example, setting a flag in memory so that when the next audio of voice burst is received, the mobile communication device will skip the process of buffering and play the audio or voice information as it is received. In an alternative path, if the software determines there is a loudspeaker present, and the mobile communication device is not presently set to a quiet mode, than the received audio or voice information will be played over the loudspeaker as it is received (420), as would otherwise be conventional.

Therefore, the inventions provides a method of receiving a dispatch call at a mobile communication device. The method commences with receiving a dispatch call at the mobile communication device, meaning an initial voice or audio burst is received. The dispatch call contains an audio or voice signal. In response to the initial voice of audio burst, the mobile communication device commences alerting the user of the mobile communication device that a dispatch call has been received. In addition, as the voice signal is being received by the mobile communication device, the mobile communication device commences buffering the voice signal in a memory of the mobile communication device. After alerting the user of the mobile communication device, the mobile communication device waits for the user's indication that the user will accept the call. Upon detecting an acceptance of the call, the mobile communication device commences playing the voice signal over an earpiece of the mobile communication device. After the initial voice burst has been accepted by the user, the mobile communication device directly plays any further voice signal received at the mobile communication device during the dispatch call. By directly playing it is meant the voice burst is not buffered. As digital information is subsequently received, packets may be momentarily buffered, but these are played in order, without being predicated upon the user indicating acceptance. The initial voice or audio burst may be buffered in encoded or un-encoded form. The alert provided to the user may be an audible or tactile/vibration alert, or both. It is contemplated that the invention may be used both by mobile communication devices with loudspeakers and those without loudspeakers. If the mobile communication device has a loudspeaker, the user may, at the user's option, set the mobile communication device into a quiet mode so that incoming dispatch calls are handled in accordance with the invention. The user may indicate acceptance in a variety of ways, such as, for example, by pressing a button, such as a push-to-talk button, by a voice command, or even a preselected time delay has elapsed after the mobile communication device has provided the alert, for example.

Since the invention can be implemented entirely under software control, the invention also provides for a memory device containing machine readable code. The code is for use in a mobile communication device, and controls the mobile communication device so that, upon receiving an initial dispatch call burst, the mobile communication device buffers the initial dispatch call burst. The software code then controls the mobile communication device to enter a mode where the mobile communication device looks for an indication of an acceptance of the dispatch call by the user. Then the machine readable code causes the mobile communication device to play the initial dispatch call burst over an earpiece of the mobile communication device.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method of receiving a dispatch call at a mobile communication device, comprising:
receiving an initial dispatch call burst at the mobile communication device;
buffering the initial dispatch call burst in a memory of the mobile communication device;
alerting a user of the mobile communication device in response to receiving the initial dispatch call burst;
detecting at the mobile communication device an acceptance of the call from the user of the mobile communication device; and
playing the initial dispatch call burst over an earpiece of the mobile communication device in response to detecting the acceptance.

2. A method of receiving a dispatch call as defined by claim 1, further comprising, subsequent to detecting acceptance of the call, directly playing subsequent dispatch call bursts received at the mobile communication device during the dispatch call.

3. A method of receiving a dispatch call as defined in claim 1, wherein receiving the initial dispatch call burst includes receiving a voice signal in voice encoded form.

4. A method of receiving a dispatch call as defined in claim 3, wherein receiving the initial dispatch call burst includes receiving the voice signal in vector sum excited linear predictive voice coding.

5. A method of receiving a dispatch call as defined in claim 1, wherein alerting the user includes an audible alert.

6. A method of receiving a dispatch call as defined in claim 1, wherein alerting the user includes an tactile alert.

7. A method of receiving a dispatch call as defined in claim 1, wherein detecting acceptance of the call includes detecting actuation of button of the mobile communication device, the button designated for operation corresponding to dispatch calls.

8. A method of receiving a dispatch call as defined in claim 1, further comprising setting the mobile communication device in a quiet mode prior to receiving the initial dispatch call burst.

9. A method of receiving a dispatch call as defined by claim 1, further comprising detecting an absence of a loudspeaker in the mobile communication device prior to commencing buffering the initial dispatch call burst.

10. A mobile communication device capable of receiving a dispatch call, comprising:
a transceiver for transmitting and receiving radio frequency signals;
a buffer memory
a user interface; and
an earpiece;
wherein upon receiving an initial dispatch call burst, the mobile communication device buffers the initial dispatch call burst in the buffer memory, and plays the initial dispatch call burst over the earpiece upon receiving an indication of acceptance from a user of the mobile communication device via the user interface.

11. A mobile communication device as defined in claim 10, wherein the mobile communication device further comprises a loudspeaker, the mobile communication device only buffers the initial call burst when the user of the mobile communication device has selected a quiet mode of operation.

12. A mobile communication device as defined in claim 10, further comprising machine readable code for detecting the absence of a loudspeaker in the mobile communication device, and automatically buffering the initial dispatch call burst.

13. A mobile communication device as defined in claim 10, wherein subsequent call bursts are played over the earpiece as they are received.

14. A memory device comprising machine readable code for use in a mobile communication device, which, upon receiving an initial dispatch call burst, causes the mobile communication device to buffer the initial dispatch call burst of a dispatch call until a user of the mobile communication device indicates an acceptance of the dispatch call, whereupon the machine readable code causes the mobile communication device to play the initial dispatch call burst over an earpiece of the mobile communication device.
